(19) United States
(12) Patent Application Publication
(10) Pub. No.: US 2025/0154062 A1
(43) Pub. Date: May 15, 2025

(54) UTILIZATION OF PETROLEUM COKE IN CEMENTITIOUS MATERIALS

(71) Applicant: SAUDI ARABIAN OIL COMPANY, Dhahran (SA)

(72) Inventors: Mohammed Al Mehthel, Dhahran (SA); Nawaf Abdulrahman Alubaidi, Dhahran (SA); Sami A. Al Abduljabbar, Dhahran (SA)

(73) Assignee: SAUDI ARABIAN OIL COMPANY, Dhahran (SA)

(21) Appl. No.: 18/510,355

(22) Filed: Nov. 15, 2023

(51) Int. Cl. C04B 18/04; C04B 20/02; C04B 40/00

(52) U.S. Cl. CPC C04B 18/049; C04B 20/026; C04B 40/0046; C04B 2201/20

(57) ABSTRACT

Provided is a cementitious composition including a cementitious material; petcoke as particles; aggregates; and water. A minimum of 80% of the petcoke has a particle size of from 0.1 μm to 45 μm, and the remaining amount of the petcoke has a particle size of less than 2 mm. Also provided is a method of producing a cementitious composition and an article including a cementitious composition.

### BACKGROUND

As of 2019, carbon dioxide (CO₂) emissions from the cement industry reached 2.4 Gt, accounting for 26% of total industrial CO₂ emissions. The development of improved low-carbon concrete is therefore extremely urgent. The use of carbon-based materials in concrete is an attractive alternative to reduce CO₂ emissions. The replacement of at least a portion of the cement or aggregates with a carbon-containing material conserves these natural resources.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a cementitious composition comprising a cementitious material; petcoke as particles; aggregates; and water, wherein a minimum of 80% of the petcoke has a particle size of from 0.1 μm to 45 μm, and the remaining amount of the petcoke has a particle size of less than 2 mm.

In another aspect, embodiments disclosed herein relate to a method of manufacturing a cementitious composition comprising a cementitious material; petcoke as particles; aggregates; and water, wherein a minimum of 80% of the petcoke has a particle size of from 0.1 μm to 45 μm, and the remaining amount of the petcoke has a particle size of less than 2 mm. The method comprises grinding petcoke to reduce the particle size to a minimum of 80% of particles having a size of from 0.1 μm to 45 μm; mixing the petcoke with a cementitious material, and optionally aggregates and/or additives to provide a cementitious dry blend; and mixing the cementitious dry blend with water, and optionally additives.

In another aspect, embodiments disclosed herein relate to an article comprising a cementitious composition comprising a cementitious material; petcoke as particles; aggregates; and water, wherein a minimum of 80% of the petcoke has a particle size of from 0.1 μm to 45 μm, and the remaining amount of the petcoke has a particle size of less than 2 mm.

Other aspects and advantages of the claimed subject matter will be apparent from the following description and the appended claims.

### DETAILED DESCRIPTION

Embodiments according to the present disclosure generally relate to cementitious compositions comprising petroleum coke (petcoke) as a replacement for at least a portion of cement and/or aggregates. The replacement of cement or aggregates with petcoke provides a cementitious compositions having increased durability and mechanical properties when compared to a similar composition which does not comprise petcoke.

### Cementitious Compositions

Embodiments disclosed herein relate to a cementitious composition comprising a cementitious material, petcoke, aggregates, water, and optionally additives. The cementitious material is not particularly limited and may be Ordinary Portland Cement, ASTM C595 cement, cement that meets ASTM C150, Ordinary Portland Cement with supplementary materials that meets ASTM C618 or ASTM C1709, cement made with silica fume or blast furnace slag, or combinations thereof. In one or more embodiments, the amount of cementitious material has a lower limit of 50, 60, 70, 80, 90, 100, or 150 kg/m³ (kg of material per m³ of concrete/mortar) to an upper limit of 200, 300, 400, or 500 kg/m³, where any lower limit may be used in combination with any upper limit.

In one or more embodiments, cementitious compositions according to the present disclosure comprise one or more aggregates. Aggregates may be either coarse or fine aggregates according to ASTM C33, or a combination thereof. Coarse aggregates may be selected from crushed aggregates, gravel, recycled materials, slag, indigenous materials, waste materials. Fine aggregates may be selected from desert sand, artificial sand, dredged materials, waste powder. Coarse aggregates may be in an amount of from a lower limit of 0, 100, 200, 300, 400, or 500 kg/m³ to an upper limit of 1000, 1100, 1200, 1300, 1400, or 1500 kg/m³, where any lower limit may be used in combination with any upper limit. Fine aggregates may be in an amount of from a lower limit of 1, 100, 200, 300, 400, or 500 kg/m³ to an upper limit of 1000, 1100, 1200, 1300, 1400, 1500 or 2000 kg/m³, where any lower limit may be used in combination with any upper limit.

In one or more embodiments, cementitious compositions according to the present disclosure comprise petroleum coke, or “petcoke”, which is dried and mixed with a cementitious material and/or aggregates as particles. Petcoke is the solid byproduct of coking processes for cracking long chain hydrocarbons. The petcoke obtained from a coker may comprise, by mass, 80 to 98% carbon, 0.1 to 10% sulfur, and 0.1 to 15% of components other than carbon and sulfur. In one or more embodiments, the petcoke has a density of from 0.9 to 1.2 g/cm³.

In embodiments, a minimum of 80% of the dried petcoke particles have a particle size ranging from 0.1 μm to 45 μm, where the remaining amount of petcoke particles have a size of less than 2 mm. The petcoke particles according to one or more embodiments have an average particle size ranging from 0.1 μm to 45 μm. Petcoke particles may have an average size ranging from a lower limit of 0.1, 0.5, 1, 5, 10, or 15 μm to an upper limit of 20, 25, 30, 35, 40, or 45 μm, where any lower limit may be used in combination with any upper limit. Grinding, or any other suitable method for reducing a particle's size, may be used to obtain the desired particle size.

Petcoke may be used to replace a corresponding amount of the cementitious material or aggregate in the cementitious composition. In embodiments, the petcoke is present in an amount of 0.01 to 10% of the cementitious material or aggregates, by mass. Petcoke may be present in an amount ranging from a lower limit of 0.01, 0.1, 0.5, 1, 2, 3, 4, or 5% to an upper limit of 5, 6, 7, 8, 9, or 10% by mass, where any lower limit may be used in combination with any upper limit.

In one or more embodiments, cementitious compositions according to the present disclosure comprise water. Water may be present in an amount ranging from 5 kg/m³ to 500 kg/m³. In one or more embodiments, the water is present in an amount ranging from a lower limit of 5, 10, 20, 30, 40, 50, 100, or 200 kg/m³ to an upper limit of 200, 300, 400, or 500 kg/m³, where any lower limit may be used in combination with any upper limit.

In one or more embodiments, cementitious compositions according to the present disclosure comprise one or more additives. Additives may be, for example, supplementary cementitious materials such as materials that meet ASTM C618, materials that meet ASTM C595, silica fume, blast furnace slag, materials that produce concrete that meet ASTM C1709, or combinations thereof; recycled plastic such as low-density polyethylene, linear low-density polyethylene, high density polyethylene, polycarbonate from electronic waste, or a combination thereof; fibers such as polypropylene, polyethylene, or combinations thereof; rubber; construction waste; fillers such as limestone powder, pozzolanic materials, oil ash, bag house dust, black carbon, or a combination thereof; composite materials such as fiber reinforced materials; dispersion agents; or foaming agents. In one or more embodiments, the cementitious compositions comprise one or more additives in an amount ranging from 50 to 500 kg/m³. Additives may be present in an amount ranging from a lower limit of 5, 10, 20, 30, 40, 50, 100, or 200 kg/m³ to an upper limit of 200, 300, 400, or 500 kg/m³, where any lower limit may be used in combination with any upper limit.

### Cementitious Composition Properties

In one or more embodiments, cementitious compositions may have a compressive strength of from 100 to 8000 psi after curing for 28 days, according to ASTM C39 for concrete and ASTM C109 for cementitious mortars. Cured cementitious compositions may have a compressive strength ranging from a lower limit of 100, 200, 300, 400, 500, 750, 1000, 1250, 1500, 1750, 2000, or 2500 psi to an upper limit of 3000, 4000, 5000, 6000, 7000, or 8000 psi, where any lower limit may be used in combination with any upper limit.

In one or more embodiments, cementitious compositions according to the present disclosure have a density which is suitable for use as, for example, foam mortar, light weight concrete, or structural concrete. Cementitious compositions for use as foam mortar may have a density of at least 300 kg/m³ after curing for 28 days. Cementitious compositions for use as light weight concrete may have a density of at least 1500 kg/m³ after curing for 28 days. Cementitious compositions for use as foam mortar may have a compressive strength of at least 2350 kg/m³ after curing for 28 days. Cementitious compositions may have a density ranging from a lower limit of 300, 400, 500, 750, 1000, 1250, 1500, 1750, 2000, or 2350 kg/m³ to an upper limit of 3000 kg/m³, where any lower limit may be used in combination with any upper limit.

### Method of Manufacturing a Cementitious Composition

Embodiments according to the present disclosure relate to a method of producing a cementitious composition. Generally, the cementitious material, petcoke, aggregates, and any additives may be mixed with water to form a cementitious composition in the form of a slurry. The composition may be cured to form a cured cement.

In one or more embodiments, prior to mixing with other components of the composition, petcoke may be dried via a suitable method, such as heat drying or air drying. The petcoke may be treated by grinding, or any other method suitable for reducing a particle size, to obtain a suitable grain or particle size. The petcoke may then be stored for later use, or may be directly mixed to form a cementitious composition.

The cementitious material, petcoke, aggregates, and any dry additives may be mixed to form a cementitious dry blend by methods known in the art. The cementitious dry blend may be mixed with water and any liquid additives to form a hydrated cementitious composition.

In one or more alternative embodiments, the petcoke may be mixed with water prior to mixing with the cementitious material and/or aggregates. The dried petcoke may be added to a mixer, such as a mechanical blender, with water and mixed at a speed and for a duration sufficient to form a suspension. The suspension may then be added to the cementitious material, aggregates, and any dry additives to form a hydrated cementitious composition.

### Article

Embodiments according to the present disclosure relate to articles comprising the cementitious composition. Articles may be formed entirely or partly of the cementitious composition and allowed to cure to form a desired article. The curing may be any suitable method for curing a cementitious composition, such as for example air drying, heat curing, water curing, curing compound, CO₂ curing, curing membrane, or any combinations thereof. Cementitious compositions may be cured for a period of at least 4 hours and of up to 28 days. Example articles may include, but are not limited to mortar, bricks, concrete structures, specially designed patterns for surface or downhole use, precaste concrete members, in-situ concrete members, cement coating, and cement lining.

The durability performance of cured articles is similar or better than concrete members made with ordinary portland cement (OPC).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A cementitious composition comprising:
a cementitious material;
petcoke as particles;
aggregates; and
water,
wherein a minimum of 80% of the petcoke has a particle size of from 0.1 μm to 45 μm, and the remaining amount of the petcoke has a particle size of less than 2 mm.

2. The cementitious composition according to claim 1, wherein the cementitious material is in an amount of from 50 to 500 kg/m³.

3. The cementitious composition according to claim 1, wherein the petcoke is in an amount of from 0.01 to 10% by mass of the cementitious material.

4. The cementitious composition according to claim 1, wherein the aggregates are:
coarse aggregates, fine aggregates, or a combination thereof; and
in an amount of from 0 to 1500 kg/m³ for coarse aggregates; and
in an amount of from 1 to 2,000 kg/m³ for fine aggregates.

5. The cementitious composition according to claim 1, wherein the water is in an amount of from 5 to 500 kg/m³.

6. The cementitious composition according to claim 1, further comprising additives in an amount of from 50 to 500 kg/m³.

7. The cementitious composition according to claim 6, wherein the additives are at least one of supplementary cementitious materials, recycled plastic, fibers, rubber, construction waste, fillers, composite materials, dispersion agents, or foaming agents.

8. The cementitious composition according to claim 7, wherein the supplementary cementitious materials are selected from the group consisting of materials that meet ASTM C618, materials that meet ASTM C595, silica fume, blast furnace slag, materials that produce concrete that meet ASTM C1709, and combinations thereof.

9. The cementitious composition according to claim 7, wherein the recycled plastic is selected from the group consisting of low-density polyethylene, linear low-density polyethylene, high density polyethylene, polycarbonate from electronic waste, and combinations thereof.

10. The cementitious composition according to claim 7, wherein the fibers are selected from the group consisting of polypropylene, polyethylene, and combinations thereof.

11. The cementitious composition according to claim 7, wherein the fillers are selected from the group consisting of limestone powder, pozzolanic materials, oil ash, bag house dust, black carbon, and combinations thereof.

12. The cementitious composition according to claim 1, wherein the cementitious material is selected from the group consisting of Ordinary Portland Cement, ASTM C595 cement, cement that meets ASTM C150, Ordinary Portland Cement with supplementary materials that meets ASTM C618 or ASTM C1709, cement made with silica fume or blast furnace slag, and combinations thereof.

13. The cementitious composition according to claim 1, wherein the petcoke comprises, by mass, 80 to 98% carbon, 0.1 to 10% sulfur, and 0.1 to 15% of components other than carbon and sulfur.

14. The cementitious composition according to claim 1, wherein the petcoke has an average particle size of 0.1 μm to 45 μm.

15. The cementitious composition according to claim 1, wherein the petcoke has a density of from 0.9 to 1.2 g/cm³.

16. The cementitious composition according to claim 1, wherein the composition has a compressive strength of 100 to 8000 psi after curing for 28 days.

17. The cementitious composition according to claim 1, wherein the composition has a density of at least 300 kg/m³ and of at most 3000 kg/m³ after curing for 28 days.

18. The cementitious composition according to claim 1, wherein the composition has a density of at least 2350 kg/m³ and of at most 3000 kg/m³ after curing for 28 days.

19. A method of manufacturing the cementitious composition according to claim 1, the method comprising:
grinding petcoke to reduce the particle size to a minimum of 80% of particles having a size of from 0.1 μm to 45 μm;
mixing the petcoke with a cementitious material, and optionally aggregates and/or additives to provide a cementitious dry blend; and
mixing the cementitious dry blend with water, and optionally additives.

20. An article comprising the cementitious composition according to claim 1.
